(19) United States
(12) Patent Application Publication
(10) Pub. No.: US 2018/0349923 A1
(43) Pub. Date: Dec. 6, 2018

(54) DYNAMIC ADAPTATION OF ADVERTISING BASED ON CONSUMER EMOTION DATA

(71) Applicant: AT&T Intellectual Property I, L.P., Atlanta, GA (US)

(72) Inventors: Gregory Edwards, Austin, TX (US); Sarah Everett, Cedar Park, TX (US); Marc Sullivan, Austin, TX (US)

(21) Appl. No.: 15/607,942

(22) Filed: May 30, 2017

(51) Int. Cl. G06Q 30/02; G06F 17/30; G10L 25/63; G06K 9/00

(52) U.S. Cl. CPC G06Q 30/0201; G06F 17/30; G06K 9/46; G06K 9/00221; G10L 25/63

(57) ABSTRACT

In one example, the present disclosure describes a device, computer-readable medium, and method for dynamically adapting advertising based on real-time data relating to consumer emotions. For instance, in one example, a method includes inferring a present emotional state of a user of a content distribution network from a set of information collected by devices in the content distribution network, determining, based at least in part on the present emotional state, a time at which to present an advertisement to the user, and dynamically adapting an advertisement presented to the user at the time in response to the present emotional state.

The present disclosure relates generally to data advertising, and relates more particularly to devices, non-transitory computer-readable media, and methods for dynamically adapting advertising based on real-time data relating to consumer emotions.

### BACKGROUND

A well-known tenet of advertising suggests that emotions drive purchase decisions, while logic justifies the purchase decisions. For instance, studies have identified a plurality of different emotional mindsets that influence how consumers make purchase decisions. As such, advertisements (e.g., television commercials, Internet advertisements, digital billboards, etc.) frequently try to appeal to the emotions of consumers in order to encourage the viewers to purchase goods and services.

### SUMMARY

In one example, the present disclosure describes a device, computer-readable medium, and method for dynamically adapting advertising based on real-time data relating to consumer emotions. For instance, in one example, a method includes inferring a present emotional state of a user of a content distribution network from a set of information collected by devices in the content distribution network, determining, based at least in part on the present emotional state, a time at which to present an advertisement to the user, and dynamically adapting an advertisement presented to the user at the time in response to the present emotional state.

In another example, a device includes a processor and a computer-readable medium storing instructions which, when executed by the processor, cause the processor to perform operations. The operations include inferring a present emotional state of a user of a content distribution network from a set of information collected by devices in the content distribution network, determining, based at least in part on the present emotional state, a time at which to present an advertisement to the user, and dynamically adapting an advertisement presented to the user at the time in response to the present emotional state.

In another example, a computer-readable medium stores instructions which, when executed by the processor, cause the processor to perform operations. The operations include inferring a present emotional state of a user of a content distribution network from a set of information collected by devices in the content distribution network, determining, based at least in part on the present emotional state, a time at which to present an advertisement to the user, and dynamically adapting an advertisement presented to the user at the time in response to the present emotional state.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for dynamically adapting advertising based on real-time data relating to consumer emotion; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a means for dynamically adapting advertising based on real-time data relating to consumer emotions. As discussed above, advertisements (e.g., television commercials, Internet advertisements, digital billboards, etc.) frequently try to appeal to the emotions of consumers in order to encourage the consumers to purchase goods and services. However, conventional advertising techniques are not well-informed when it comes to the emotional state of a consumer at the time that the consumer is experiencing (e.g., seeing or hearing) the advertisement. For instance, the consumer's present emotional state may make him less receptive to a television commercial having a particular tone or depicting a particular product or service.

Examples of the present disclosure collect user-specific data from sensors, devices, and social media that can be used to infer a present emotional state of a particular user. Advertising material that is subsequently presented to the user, such as television or radio commercials, digital billboards, Internet advertisements, or the like, is then dynamically adapted in response to the inferred present emotional state. The user's present emotional state could also be inferred during and/or after presentation of the advertising material, in order to gauge an impact of the advertising material on the user's emotional state. This information could, in turn, be used to better inform the selection of advertising material that is presented to the user in the future. Thus, the advertising material is more effective from the advertising perspective and more pleasant from the consumer perspective.

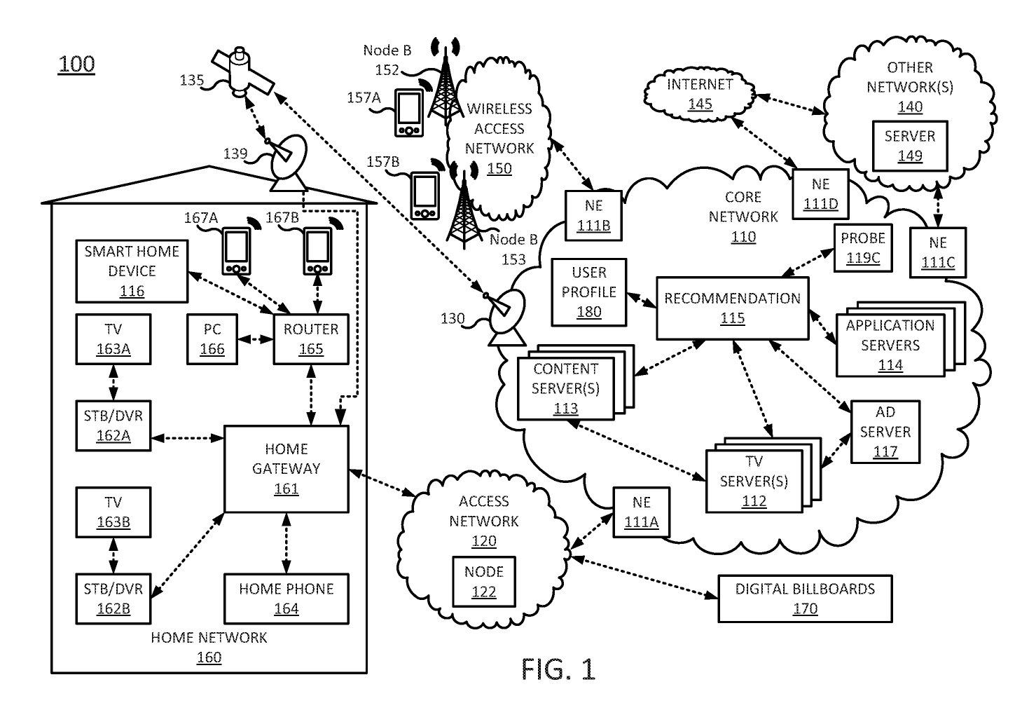

To better understand the present disclosure, FIG. 1 illustrates an example network 100, related to the present disclosure. As shown in FIG. 1, the network 100 connects mobile devices 157A, 157B, 167A and 167B, digital billboards 170, and home network devices such as home gateway 161, set-top boxes (STBs) 162A, and 162B, television (TV) 163A and TV 163B, home phone 164, router 165, personal computer (PC) 166, smart home device 116 (e.g., smart thermostat, smart lighting system, intelligent personal assistant, etc.), and so forth, with one another and with various other devices via a core network 110, a wireless access network 150 (e.g., a cellular network), an access network 120, other networks 140 and/or the Internet 145. Mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and smart home device 116 may also be referred to herein as “customer devices” or “user endpoint devices.”

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a global positioning system (GPS), a satellite radio receiver or satellite television receiver, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, a recommendation server 115, and a user profile database 180. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113 and advertising server 117 to select which video programs, or other content and advertisements to provide to the home network 160 and to others.

In one example, content servers 113 may store scheduled television broadcast content for a number of television channels, video-on-demand programming, local programming content, and so forth. For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160, on the digital billboards 170, via the mobile devices 157A, 157B, 167A, and 167B, and at other downstream viewing locations. For example, advertisers may upload various advertising content to the core network 110 to be distributed to various viewers.

In one example, one or more of the application servers 114 hosts a social media application, e.g., an Internet-based application via which users create and share of information. For instance, the social media application may comprise a personal and/or professional social networking application, a blogging or microblogging application, an image or video sharing application, a web feed, or the like. The social media application maintains a profile for each user of the social media application, which the user can update at any time.

The user profile database 180 may store profiles for individual users of the network 100, as well as for groups of users of the network 100. A user profile for a given user may indicate, for example, the types of advertisements that the user responds to positively and/or negatively when experiencing different emotional states. As an example, the user's profile may indicate that when the user is sad, he or she responds positively to funny advertisements, but responds negatively to sad advertisements. The user's profile could also indicate that the user generally responds positively to advertisements to certain types of products or services (e.g., furniture), but responds negatively to advertisements for other types of products or services (e.g., political advertisements). The user profile may also indicate the user's preferences regarding advertisement content and/or tone at different times of the day (e.g., no violence before 8:00 PM or at other times when children are likely to be present). The content of the user profiles could be controlled by the users with which they are associated, and could also be supplemented with information from the recommendation server 115 as described below. The content of the user profiles could also be updated at any time, by either the associated user(s) or by the recommendation server 115. In a further example, an authorized third party (e.g., a parent, a doctor, or the like) could also control and update the content of a user's profile. A profile for a group of users might include the same information, but for a particular group (e.g., a family, a crowd in a sports stadium, etc.). Profiles stored in the user profile database 180 may be encrypted to protect user privacy.

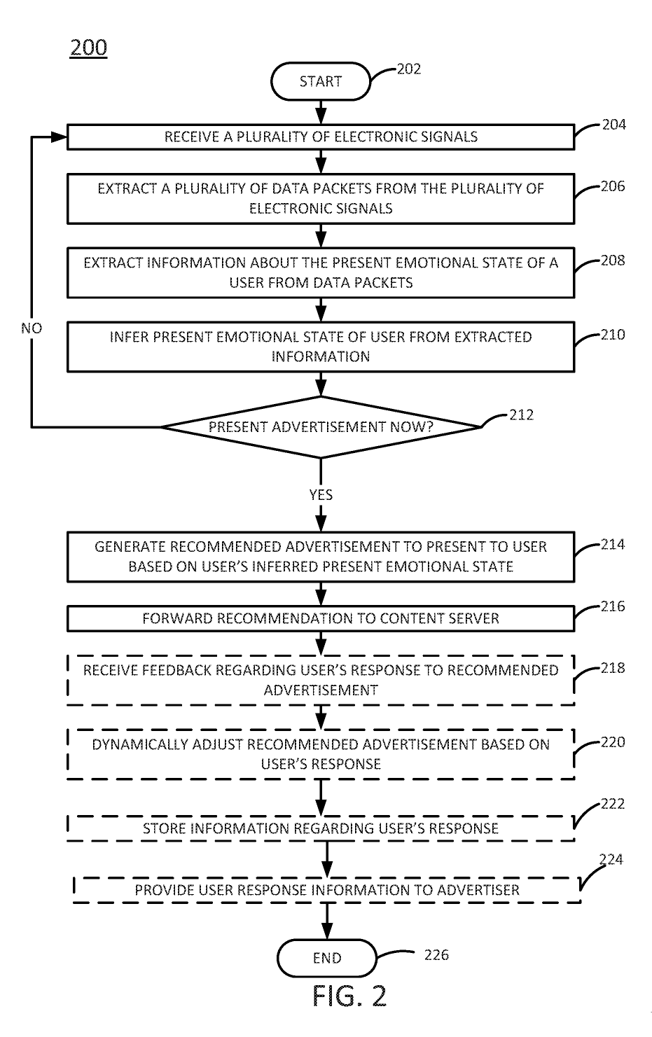

In one example, the recommendation server 115 infers the present emotional state of a user or group of users in the network 100. For instance, the recommendation server 115 may synchronize and merge data from customer devices (e.g., mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and/or smart home devices 116), from the core network (e.g., from network elements 111A-111D, television (TV) servers 112, content servers 113, application servers 114, advertising server (AS) 117, and network management system 116), and from other sources. The recommendation server 115 may be able to further generate a recommendation regarding a specific piece of advertising material or a general tone of advertising material to be targeted to a specific user or group of users, as discussed in further detail below in connection with FIG. 2. The recommendation server 115 may also be able to generate a recommendation regarding the timing and manner with which the advertising material is presented to the user or group of users.

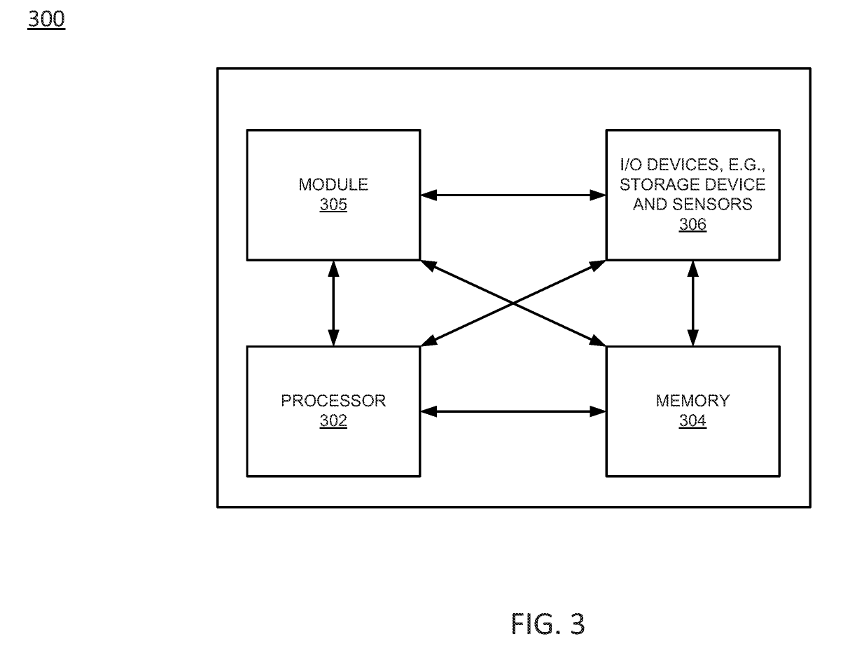

In one example, any or all of the television servers 112, content servers 113, application servers 114, recommendation server 115, and advertising server 117 may comprise a computing system, such as computing system 300 depicted in FIG. 3

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data files are forwarded to set-top boxes (STBs)/digital video recorders (DVRs) 162A and 162B to be decoded, recorded, and/or forwarded to television (TV) 163A and TV 163B for presentation or to connected home devices (CHDs) 170A and 170B for further action. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

To further aid in understanding the present disclosure, FIG. 2 illustrates a flowchart of an example method 200 for dynamically adapting advertising based on real-time data relating to consumer emotions. In one example, the method 200 may be performed by a server such as the recommendation server 115 and/or one or more of the application server(s) 114 illustrated in FIG. 1. However, in other examples, the method 200 may be performed by another device (e.g., another application server or locally by mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and/or smart home devices 116). As such, any references in the discussion of the method 200 to recommendation server 115 and/or application server(s) 114 of FIG. 1 are not intended to limit the means by which the method 200 may be performed.

The method 200 begins in step 202. In step 204, the recommendation server 115 receives a plurality of electronic signals. The electronic signals are received over a combination of the core network 110, access network 120 and/or wireless access network 150. The senders of the electronic signals may include mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and/or smart home devices 116. The senders of the electronic signals may also include the television servers 112, content servers 113, application servers 114, and advertising server 117. The senders of the electronic signals may be configured to send information via the electronic signals at specific times or in response to specific events. For instance, a home network device may be configured to send information starting at a predefined time (e.g., one minute) before a scheduled commercial break in a television program. A digital billboard may be configured to send information as pedestrians walk past it. Other devices may be configured to send information only when a user is present.

In step 206, the recommendation server 115 extracts a plurality of data packets from the electronic signals received in step 204. For instance, each electronic signal may contain one or more data packets whose header indicates that the recommendation server 115 is its intended destination.

In step 208, the recommendation server 115 extracts real-time information about the present emotional state of a user (or a group of users) of the network 100 from the data packets (e.g., from the payloads of the data packets). Extraction of the information from the data packets may involve decrypting the data packets and/or reassembling the information from the portions of the information that are contained in individual data packets. The information is considered to be real-time in the sense that it is transmitted nearly instantaneously after being captured, but transmission of the information may be subject to some amount of delay depending on network conditions.

The information about the user's present emotional state may come from real-time still and/or video images of the user, real-time audio of the user, real-time text messages sent or received by the user, a present location of the user (e.g., geographic coordinates, work versus home, etc.), and/or other user information recorded by a sensor in a user's mobile phone, smart home device, Internet of things, or other device. The information about the user's present emotional state may also come from social media postings made by the user and/or members of his or her social network and stored by one or more of the application servers 114. In one example, the user gives his or her permission for the information to be shared with the recommendation server 115. The permission may be an open consent (e.g., permission to share certain types of data at any time until/unless the permission is revoked), or the permission may be granted each time a device intends to send information to the recommendation server (e.g., permission to share a specific video or social media posting).

In step 210, the recommendation server 115 infers the present emotional state of the user (or group of users) from the information extracted in step 208. For example, if the information extracted in step 208 was a social media post in which the user expressed sadness, then the recommendation server 115 may infer that the user is sad. Alternatively, if the information extracted in step 208 was a video in which the user appeared to be very busy, the recommendation server 115 may infer that the user is distracted.

In step 212, the recommendation server 115 determines whether to present an advertisement to the user at the current time, based on the user's inferred present emotional state. For instance, if the user appears to presently be distracted, then it may not be a good time to present an advertisement to him or her. Similarly, if the user presently appears to be engaged in an activity (e.g., watching a television show, driving, having a conversation), then it also may not be a good time to present an advertisement. However, if the user presently appears to be bored or not fully engaged, then it may be a good time to present an advertisement.

If the recommendation server 115 concludes in step 212 that an advertisement should not be presented to the user at the current time, then the method 200 returns to step 204, and the recommendation server 115 continues to receive updated information from which to infer the present emotional state of the user (or group of users).

If, however, the recommendation server 115 concludes in step 212 that an advertisement should be presented to the user at the current time, then the method 200 proceeds to step 214. In step 214, the recommendation server 115 generates a recommended advertisement (e.g., a television or radio commercial, and Internet advertisement, a digital billboard advertisement, etc.) to present to the user, based on the user's inferred present emotional state. For instance, if the recommendation server 115 infers that the user is presently sad, then the recommendation server 115 may recommend presenting a particular advertisement to the user that has a generally upbeat tone or that promotes a “feel good” product. Alternatively the recommendation server 115 may recommend presenting a particular advertisement to the user that has a generally melancholy tone. The choice of what type of advertisement to present based on the user's inferred present emotional state may be based in part on knowledge of how the user responded to particular types of advertisements in the past, when exhibiting a similar inferred emotional state. For example, if the user reacted negatively in the past to an upbeat advertisement that was presented when he or she was assumed to be sad, and it is inferred that the user is presently sad, then the recommended advertisement based on the present emotional state may have a more melancholy tone. Knowledge of the user's past responses may be obtained from a user profile store din the user profile database 180. The advertisement that is recommended in step 214 may be an advertisement that is stored on the advertising server 117.

In step 216, the recommendation server 115 forwards the recommendation generated in step 214 to the content server 113, which may, in turn, present the recommended advertisement to the user. For instance, the content server 113 may forward the recommended advertisement to one of the mobile devices 157A, 157B, 167A, or 167B associated with the user or to one of the STB/DVRs 162A or 162B in the user's home. As an example, the recommended advertisement may comprise a television commercial displayed on the television the user is presently watching, a radio commercial played on a radio to which the user is currently listening, or an advertisement displayed on a web site that the user is presently viewing. The content server could also forward the recommended advertisement to a digital billboard 170 that the user is expected to encounter within some threshold period of time (based on knowledge of the user's present location).

In optional step 218 (illustrated in phantom), the recommendation server 115 receives feedback indicating the user's emotional response to the recommended advertisement. The feedback may comprise an explicit indication from the user that he or she did or did not like the advertisement (e.g., a response to a query seeking the user's feedback). The feedback may additionally or alternatively comprise an implicit indication of the user's response (e.g., information similar to that extracted in step 208). For instance, video of the user's facial expressions during presentation of the recommended advertisement could be used to infer the user's response to the recommended advertisement.

In optional step 220 (illustrated in phantom), the recommendation server 115 may adjust the recommended advertisement based on the user's response. For instance, a television commercial could be filmed with a plurality of different endings (e.g., funny, serious, etc.), and which ending is presented to the user may depend on the user's response to the earlier portions of the commercial. A television commercial could also be filmed to have a plurality of different lengths (e.g., a full-length version, an abbreviated version, etc.), and which length is presented to the user may depend on the level of attention paid by the user to the earlier portions of the commercial. Alternatively, if a user shows no interest at all in the recommended advertisement, the recommended advertisement could switch to an alternative advertisement.

In optional step 222 (illustrated in phantom), the recommendation server 115 may store information regarding the user's response to the recommended advertisement. For instance, the information could be stored in a user profile associated with the user that is used to guide and refine the selection of advertisements that are presented to the user in the future. Thus, if the user tends responds positively to advertisements for a certain type of product or service (e.g., furniture) or to advertisements having a certain tone (e.g., humorous), similar advertisements could be presented to the user in the future (e.g., when the user's emotional state is similar to his or her current emotional state). Alternatively, if the user tends to respond negatively to such advertisements, the recommendation server 115 may learn not to present similar advertisements to the user in the future.

In optional step 224, (illustrated in phantom), the recommendation server 115 may provide information about the user's response to an advertiser (e.g., the advertiser who provided the recommended advertisement). This information could help the advertiser to gauge the effectiveness of their advertisements and to determine the appropriate tone, content, and/or timing for future advertisements. In a further example, information about the user's response could also be provided to a doctor, parent, or other caregiver to whom the user's emotional state may be relevant. The user's permission may be solicited before sharing his or her response information with any third parties.

The method 200 ends in step 226.

Although the method 200 describes inferring the present emotional state of, and recommending an advertisement to present to, a single user or group of users, it is noted that the method 200 could be implemented to simultaneously infer the emotional states of, and generate recommended advertisements for, a plurality of different users and groups of users. In this case, the plurality of users (or groups of users) may exhibit a plurality of different emotional states, and the recommended advertisements that are targeted to each of the users (or groups of users) may be different.

Moreover, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps, or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, an application server or controller (such as might be used to perform the method 200) could be implemented as illustrated in FIG. 3.

As depicted in FIG. 3, the system 300 comprises a hardware processor element 302, a memory 304, a module 305 for dynamically adapting advertising based on real-time data relating to consumer emotions, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for dynamically adapting advertising based on real-time data relating to consumer emotions may include circuitry and/or logic for performing special purpose functions relating to inferring user emotions and recommending relevant advertising. The input/output devices 306 may include, for example, a camera, a video camera, storage devices (including but not limited to, a tape drive, a floppy drive, a hard disk drive or a compact disk drive), a receiver, a transmitter, a display, an output port, or a user input device (such as a keyboard, a keypad, a mouse, and the like).

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for dynamically adapting advertising based on real-time data relating to consumer emotions (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for dynamically adapting advertising based on real-time data relating to consumer emotions (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method, comprising:
inferring a present emotional state of a user of a content distribution network from a set of information collected by devices in the content distribution network;
determining, based at least in part on the present emotional state, a time at which to present an advertisement to the user; and
dynamically adapting an advertisement presented to the user at the time, in response to the present emotional state.

2. The method of claim 1, wherein the dynamically adapting is based at least in part on a user profile associated with the user, wherein the user profile indicates how the user has responded in the past to different types of advertisements when exhibiting an emotional state that is similar to the present emotional state.

3. The method of claim 1, wherein the user profile further specifies a preference of the user regarding specific times at which to be presented with specific types of advertising.

4. The method of claim 1, wherein the set of information includes a real-time image of the user.

5. The method of claim 1, wherein the set of information includes real-time audio of the user.

6. The method of claim 1, wherein the set of information includes a text message on which the user is a sender or a recipient.

7. The method of claim 1, wherein the set of information includes a present location of the user.

8. The method of claim 1, wherein the set of information includes a social media posting made by the user or a member of a social network of the user.

9. The method of claim 1, wherein the advertisement is a television commercial displayed on a television that the user is presently watching.

10. The method of claim 1, wherein the advertisement is a radio commercial displayed on a radio to which the user is presently listening.

11. The method of claim 1, wherein the advertisement is displayed on a web site that the user is presently viewing.

12. The method of claim 1, wherein the advertisement is displayed on a digital billboard that the user expected to encounter at the time.

13. The method of claim 1, further comprising:
subsequent to the dynamically adapting, receiving feedback that indicates an emotional response of the user to the advertisement.

14. The method of claim 13, further comprising:
updating a user profile associated with the user based on the emotional response, wherein the user profile indicates how the user has responded in the past to different types of advertisements when exhibiting an emotional state that is similar to the present emotional state.

15. The method of claim 13, further comprising:
repeating the dynamically adjusting based on the emotional response.

16. The method of claim 13, wherein the repeating the dynamically adjusting comprises:
presenting the user with an ending selected from among a plurality of potential endings for the advertisement, wherein the ending is selected based on the emotional response.

17. The method of claim 1, wherein the dynamically adapting comprises adapting a tone of the advertisement in response to the present emotional state.

18. The method of claim 1, wherein the dynamically adapting comprises adapting a product or service depicted in the advertisement in response to the present emotional state.

19. A device, comprising:
a processor; and
a computer-readable medium storing instructions which, when executed by the processor, cause the processor to perform operations comprising:
inferring a present emotional state of a user of a content distribution network from a set of information collected by devices in the content distribution network;
determining, based at least in part on the present emotional state, a time at which to present an advertisement to the user; and
dynamically adapting an advertisement presented to the user at the time, in response to the present emotional state.

20. A computer-readable medium storing instructions which, when executed by the processor, cause the processor to perform operations comprising:
inferring a present emotional state of a user of a content distribution network from a set of information collected by devices in the content distribution network;
determining, based at least in part on the present emotional state, a time at which to present an advertisement to the user; and
dynamically adapting an advertisement presented to the user at the time, in response to the present emotional state.
